(19) United States
(12) Patent Application Publication
(10) Pub. No.: US 2026/0148339 A1
(43) Pub. Date: May 28, 2026

(54) VISION-LANGUAGE MODEL WITH IMPROVED ACCURACY

(71) Applicant: INTUIT INC., Mountain View, CA (US)

(72) Inventors: Shon MENDELSON, Tel Aviv (IL); Yuan ZHOU, Mountain View, CA (US); Justin Rui Chang CHIANG, San Diego, CA (US); Daniel Wen ZHANG, Mountain View, CA (US)

(73) Assignee: INTUIT INC., Mountain View, CA (US)

(21) Appl. No.: 18/962,894

(22) Filed: Nov. 27, 2024

(51) Int. Cl. G06T 3/4053; G06T 3/4046

(52) U.S. Cl. CPC G06T 3/4053; G06T 3/4046

(57) ABSTRACT

A method of providing a vision-language model with improved accuracy. A command is received for a vision-language model to extract target information from an initial image data structure. The vision-language model is incapable of extracting the target information within a predetermined degree of accuracy. A super-resolution machine learning model is executed on the initial image data structure to output an enhanced image data structure. The enhanced image data structure includes a higher pixel resolution than the initial image data structure. A prompt is generated that includes the enhanced image data structure and an instruction to extract the target information from the enhanced image data structure. The vision-language model is executed on the prompt to output the target information with at least the predetermined degree of accuracy and the target information is presented.

### BACKGROUND

Vision-language models, such as large vision-language models (e.g., Gemini 1.0 Pro Vision), are deep learning machine learning models (e.g., neural networks) trained to process multimodal inputs and generate an output related to the multimodal input. For example, a vision-language model may be the software engine that drives image captioning, wherein the input is an image and an output is a text caption that describes the image.

Vision-language models alone may be incapable of extracting, from an image of low-resolution or low-quality, information to a desired degree of accuracy. For example, it may be difficult to extract information from an image of a document that was handwritten.

The above outlined technical problem may present difficulty when using the vision-language model to extract information from an image for the purpose of modifying or outputting the extracted information. For example, the vision-language model may be used to extract text from a low-resolution or low-quality image and to output the extracted text to another process for use by that other process. However, the extracted text may be inaccurate due to the vision-language model's incapability of extracting the information within the desired degree of accuracy from the low-resolution or low-quality image. As such, the vision-language model cannot be used in such a circumstance.

Thus, a technical problem exists, specifically providing a vision-language model that can extract information from an image to a predetermined degree of accuracy. More specifically, the image may be of a low resolution or low quality such that the vision-language model cannot extract the information from the image to the predetermined degree of accuracy.

### SUMMARY

One or more embodiments provide for a method providing a vision-language model with improved accuracy. The method includes receiving a command for a vision-language model to extract target information from an initial image data structure. The vision-language model is incapable of extracting the target information within a predetermined degree of accuracy. The method also includes executing a super-resolution machine learning model on the initial image data structure to output an enhanced image data structure. The enhanced image data structure includes a higher pixel resolution than the initial image data structure. The method also includes generating a prompt. The prompt includes the enhanced image data structure and an instruction to extract the target information from the enhanced image data structure. The method also includes executing the vision-language model on the prompt to output the target information with at least the predetermined degree of accuracy. The method also includes presenting the target information.

One or more embodiments provide for a system providing a vision-language model with improved accuracy. The system includes a computer processor and a data repository in communication with the computer processor. The data repository stores a command, target information, an initial image data structure, a predetermined degree of accuracy, an enhanced image data structure, and a prompt. The prompt includes the enhanced image data structure and an instruction. The system also includes a vision-language model which, when executed by the computer processor on the prompt, outputs the target information. The system also includes a super-resolution machine learning model which, when executed by the computer processor on the initial image data structure, outputs the enhanced image data structure. The system also includes a server controller which, when executed by the computer processor, presents the target information.

One or more embodiments provide for a method providing a vision-language model with improved accuracy. The method includes receiving a command for a vision-language model to extract target information from an initial image data structure. The vision-language model is incapable of extracting the target information with a predetermined degree of accuracy and the initial image data structure includes a number of pixels. The method also includes executing an enhanced deep super-resolution (EDSR) network on the initial image data structure to output an enhanced image data structure. The enhanced image data structure includes a higher pixel resolution than the initial image data structure. The EDSR network includes a convolutional neural network having an architecture having a residual block. The residual block includes one or more layers. Each layer of the one or more layers includes one or more convolutional layers that filter the initial image data for a feature and generates a corresponding feature map for the feature. Each pixel of the number of pixels in the feature map includes at least one of a positive value and a negative value. Each layer also includes one or more rectified linear unit functions that detect the feature in the feature map by scoring the negative value in each pixel as zero and the positive value in each pixel as the positive value. Each layer also includes one or more skip connections that add the output of an initial layer of the one or more layers as input to a later layer of the one or more layers. The architecture also includes an upsampling block that generates the enhanced image data structure by increasing the dimension of each pixel. The convolutional neural network does not have a batch normalization layer. The method also includes generating a prompt. The prompt includes the enhanced image data structure and an instruction to extract the target information from the enhanced image data structure. The method also includes executing the vision-language model on the prompt to output the target information with at least the predetermined degree of accuracy. The method also includes presenting the target information.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for providing a vision-language model with improved accuracy, in accordance with one or more embodiments.

FIG. 3 shows a dataflow of a method for providing a vision-language model with improved accuracy, in accordance with one or more embodiments.

FIG. 4A shows an image prior to enhancement, in accordance with one or more embodiments.

FIG. 4B shows the image of FIG. 4A after enhancement, in accordance with one or more embodiments.

FIG. 5A and FIG. 5B show an example of a computing system, in accordance with one or more embodiments.

Like elements in the various figures are denoted by like reference numerals for consistency.

### DETAILED DESCRIPTION

One or more embodiments are directed to a vision-language model with enhanced accuracy. The vision-language model solves at least the above-mentioned technical problem. The technical problem, again, is providing a vision-language model that can extract information from a low-resolution or low-quality image to a predetermined degree of accuracy. A summary of the procedure used to solve the technical problem is now presented.

Initially, an initial image data structure is received (i.e., an image). The vision-language model is commanded to extract target information from the initial image data structure. The target information can be, for example, text visible in the initial image data structure. The initial image data structure may be determined to have low-resolution or low-quality such that the vision-language model cannot extract the target information within a target or predetermined degree of accuracy. Thus, a super-resolution machine learning model is executed on the initial image data structure to output an enhanced image data structure which has a higher pixel resolution than the initial image data structure.

More specifically, the super-resolution machine learning model may be an enhanced deep super resolution (EDSR) network that utilizes a convolutional neural network (CNN). The CNN can include at least one residual block and at least one upsampling block. Each residual block includes one or more layers. For example, each layer can include convolutional layers that filter the initial image data structure for a feature and generates a corresponding feature map for the feature. The feature can be, for example, an edge feature, a shape-based feature, a texture feature, a color and intensity feature, a corner feature, or a blob feature. The feature map includes a number of pixels, and each pixel has a positive value or a negative value. Each layer also includes a rectified linear unit function that then detects the feature in the feature map by scoring the negative value in each pixel as zero and the positive value in each pixel as the positive value. Each layer also includes one or more skip connections that then adds an output of an initial layer of the one or more layers as input to a later layer of the one or more layers.

The upsampling block of the CNN then generates the enhanced image data structure by increasing a dimension of each scored pixel. In other words, the upsampling block increases the resolution of the initial image data structure to generate the enhanced image data structure. Notably, some super-resolution machine learning models include a batch normalization layer, whereas the EDSR network specifically does not include the batch normalization layer. Such exclusion of the batch normalization layer may decrease memory usage during training.

Once the enhanced image data structure is provided, a prompt is then generated that includes at least the enhanced image data structure and an instruction to extract the target information from the enhanced image data structure. The prompt is provided as an input to the vision-language model. The target information is extracted to at least the predetermined accuracy by the vision-language model. The target information is then presented as an output of the vision-language model. Thus, one or more embodiments provide for a vision-language model that utilizes a super-resolution machine learning model to improve an accuracy of the vision-language model when extracting target information from an image data structure.

As a specific example, a vision-language model may be used to extract target information such as text from an initial image data structure. The initial image data structure may be an initial image of a hand-written document in which the text may be blurry or otherwise difficult to analyze. The initial image may be determined to have insufficient resolution or quality such that the vision-language model cannot successfully extract the text from the image. In some embodiments, an initial prompt including the initial image can be provided to a vision-language model with instructions to determine if the initial image has insufficient resolution. In other embodiments, user input can be provided that determines that the initial image has insufficient resolution.

Thus, based on the determination that the initial image has insufficient resolution, the initial image is provided to a super-resolution machine learning model. The super-resolution machine learning model outputs an enhanced image which has a higher pixel resolution than the initial image. Thus, the enhanced image is less blurry and easier to analyze than the initial image. A prompt including the enhanced image and instructions to extract text from the enhanced image can then be generated and provided to the vision-language model. The vision-language model then extracts the text as output and the text can be presented for future processing or presented to a user.

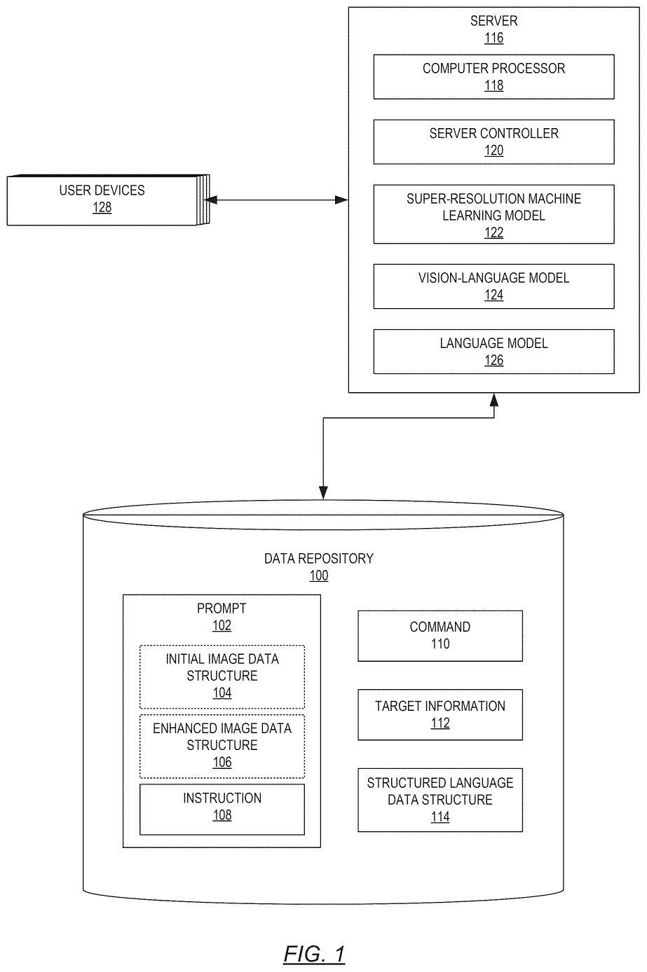

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may include a prompt (102). The prompt (102) is a set of data that can be interpreted and understood by a vision-language model (124) (described below) and that describes a desired output of the vision-language model (124). The prompt (102) can include, for example, natural language text and/or media (i.e., images or video), as well as a command to describe the desired output. Additionally, the prompt (102) also may include example(s) of the desired output for the vision-language model (124).

In at least one embodiment, the prompt (102) includes an initial image data structure (104) (described below) and instructions (108) (also described below) to determine a resolution or a quality of the initial image data structure (104). In other embodiments, the prompt (102) includes an enhanced image data structure (106) and an instruction (108) to extract target information (112) (described below) from the enhanced image data structure (106) (described below).

As described above, the prompt (102) may include the initial image data structure (104). The initial image data structure (104) includes a number of pixels having a pixel resolution (also referred to as a resolution). In some embodiments, the initial image data structure (104) defines a single image and in other embodiments, the initial image data structure (104) may define more than one image. The initial image data structure (104) may be, for example, an image of a document. In other examples, the initial image data structure (104) may be an image of another type, such as for example an image of an area.

The prompt (102) may also include the enhanced image data structure (106). Like the initial image data structure (104), the enhanced image data structure (106) also includes a number of pixels and has a higher pixel resolution than the initial image data structure (104). As will be described in more detail below at the super-resolution machine learning model (122), the enhanced image data structure (106) is formed from the initial image data structure (104). In some instances, the enhanced image data structure (106) may define a single enhanced image that is formed from the single image of the initial image data structure (104).

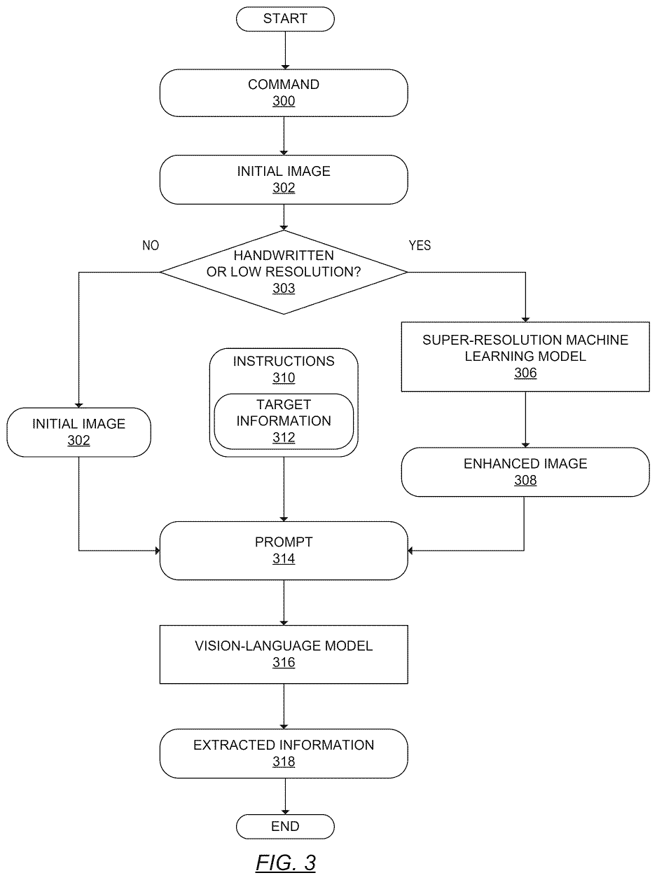

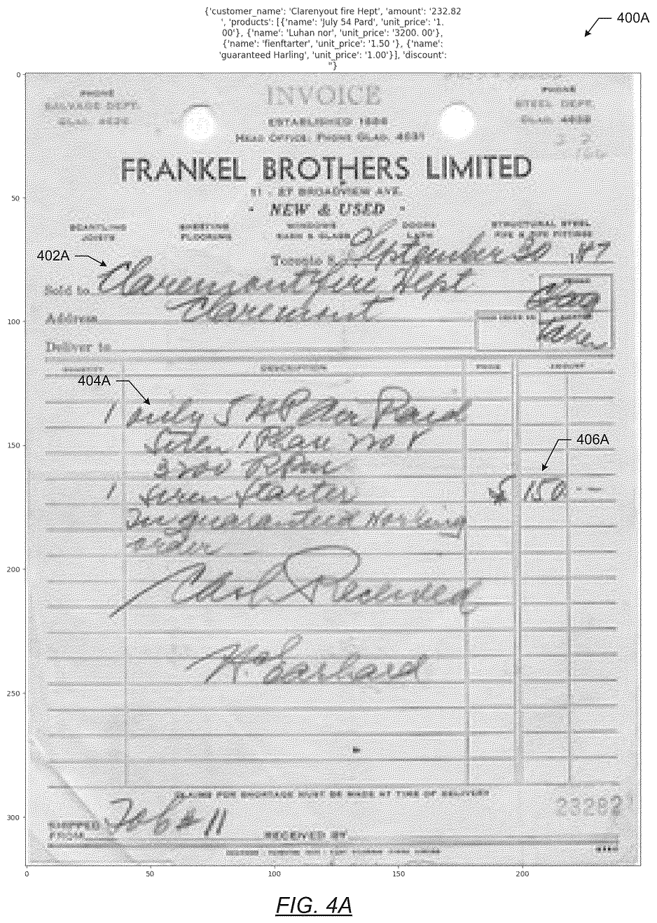

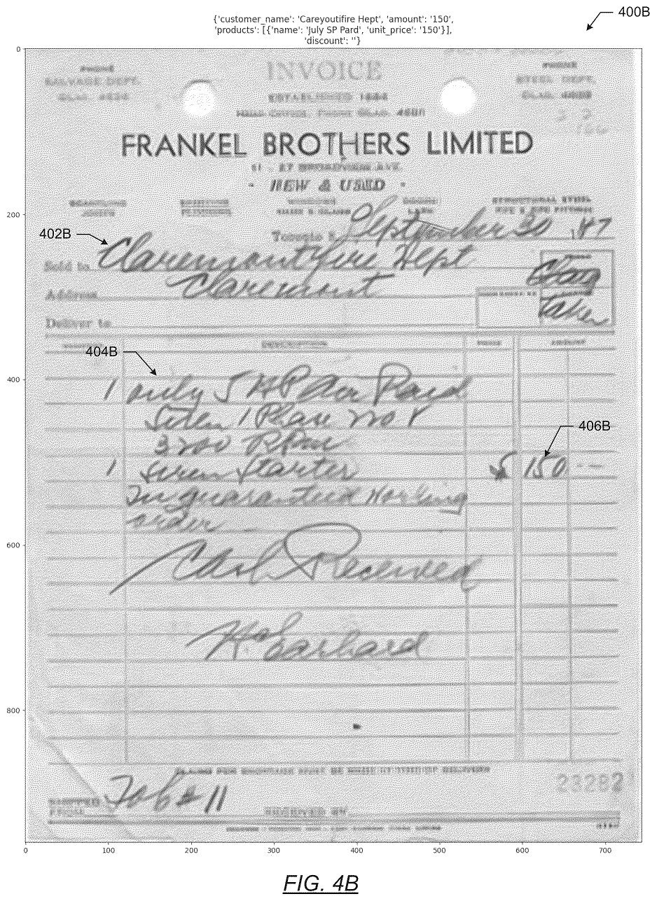

The prompt (102) includes one or more instructions (108). The instructions (108) are directions describing how the vision-language model (124) is to generate a desired output. In an example, the instructions (108) to generate the output may include instructions (108) to determine a resolution or quality of the initial image data structure (104). In another example, the instructions (108) to generate the output may include instructions (108) to extract that target information (112) from the enhanced image data structure (106). The instructions (108) may include details such as to extract specific fields of information from the enhanced image data structure (106), as will be described in more specific examples in FIG. 3, FIG. 4A, and FIG. 4B.

The data repository (100) also includes a command (110). The command (110) instructs the vision-language model (124) or a language model (126) (described below) to perform a specific task. More specifically, the command (110) may instruct the vision-language model (124) or the language model (126) to execute the instructions (108) provided in the prompt (102).

The data repository (100) also includes target information (112). The target information (112) is information in the enhanced image data structure (106) or the initial image data structure (104) to be extracted. For example, the target information (112) may be text, images, or other media to be extracted from the enhanced image data structure (106) or, in some instances, extracted from the initial image data structure (104). In some embodiments, the target information (112) may be specific fields of information to extract from the enhanced image data structure (106). For example, the target information (112) may be a component name, a component function, etc. The target information (112) will be described in more specific examples in FIG. 3, FIG. 4A and FIG. 4B.

The data repository (100) also includes a structured language data structure (114). The structured language data structure (114) is data that is organized or divided into standardized or predefined pieces expressed in a computer readable format. For example, structured language data structure (114) may include a listing of users by name, address, and ages organized into columns and rows. In some examples, an example of a structured language data structure (114) is JAVASCRIPT® Object Notation language (JSON). The target information (112), once extracted, may be formatted into a structured language data structure (114) for further processing or storage.

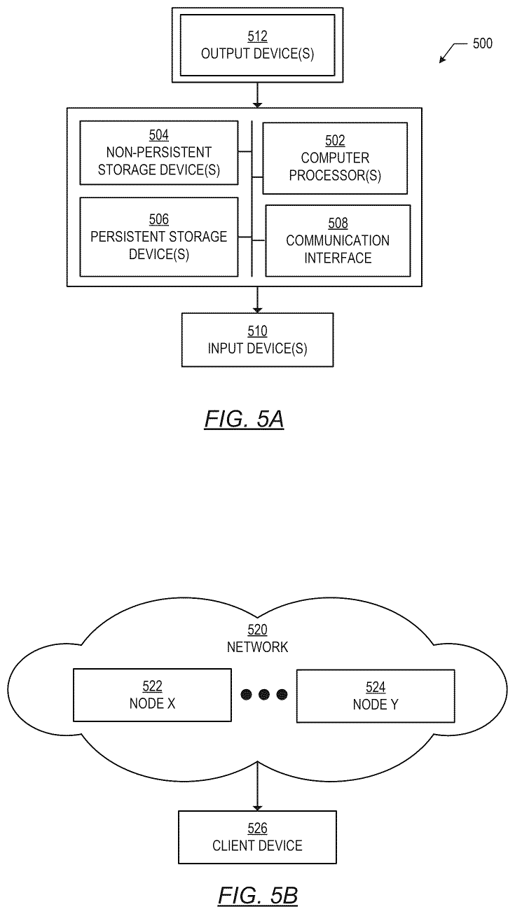

The system shown in FIG. 1 may include other components. For example, the system shown in FIG. 1 also may include a server (116). The server (116) is one or more computer processors, data repositories, communication devices, and supporting hardware and software. The server (116) may be in a distributed computing environment. The server (116) is configured to execute one or more applications, such as the vision-language model (124), the language model (126) or the super-resolution machine learning model (122). An example of a computer system and network that may form the server (116) is described with respect to FIG. 5A and FIG. 5B.

The server (116) includes a computer processor (118). The computer processor (118) is one or more hardware or virtual processors which may execute computer readable program code that defines one or more applications, such as the vision-language model (124), the language model (126) or the super-resolution machine learning model (122). An example of the computer processor (118) is described with respect to the computer processor(s) (502) of FIG. 5A.

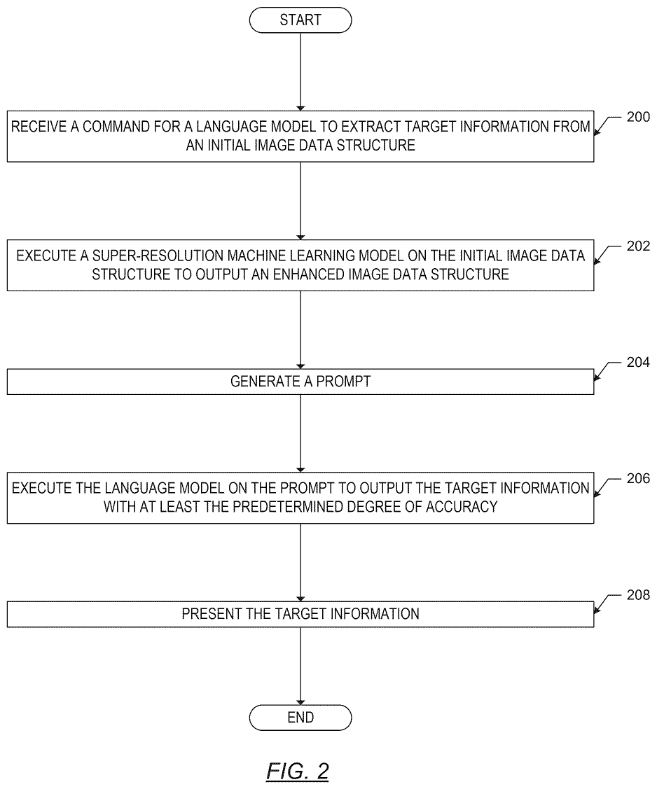

The server (116) also includes the vision-language model (124). The vision-language model (124) is a machine learning model that receives and processes multimodal inputs. Multimodal inputs include a combination of two or more of text, images, or video. An example of the vision-language model (124) is Gemini 1.0 Pro Vision. However, many different vision-language models may be used. Use of the vision-language model (124) is described with respect to FIGS. 2 and 3.

In some embodiments, the vision-language model (124) is incapable of extracting the target information (112) from the initial image data structure (104) to a predetermined degree of accuracy when the resolution of the initial image data structure (104) is below a threshold. The predetermined degree of accuracy is a measure of how close the extracted target information (112) is to the actual information. In other words, the predetermined degree of accuracy is a difference between the extracted target information (112) and the actual information in an image data structure. The predetermined degree of accuracy may be a percentage such as, for example, 80%, 90%, etc.

The server (116) also includes a language model (126). The language model (126) is a natural language processing machine learning model. An example of the language model (126) may be a large language model, such as CHATGPT®. However, many different language models may be used. Use of the language model (126) is described with respect to FIG. 2.

The server (116) also includes a super-resolution machine learning model (122). Super-resolution is defined as an enhancement or increase in a resolution of an image. Thus, the super-resolution machine learning model (122) can receive an image as an input and output an enhanced version of the image. For example, the super-resolution machine learning model (122) may receive the initial image data structure (104) and output the enhanced image data structure (106). Thus, the super-resolution machine learning model (122) can improve an accuracy of the vision-language model (124) by providing an enhanced image to the vision-language model (124). The enhanced image enables or increases a chance that the vision-language model (124) can extract the target information from the enhanced image to the predetermined degree of accuracy. In such instances, the vision-language model (124) cannot extract the target information from the image prior to application of the super-resolution machine learning model (122).

The super-resolution machine learning model (122) is capable of receiving an image and outputting an enhanced version of the image. For example, the super-resolution machine learning model (122) may be an enhanced deep super-resolution (EDSR) network, a multi-scale deep super-resolution system, a super-resolution residual network, a super-resolution convoluted neural network, very deep super resolution, etc. The super-resolution machine learning model (122) can also be a single-scale architecture in which the initial image data structure (104) is processed at a single super-resolution scale. Alternatively, the super-resolution machine learning model (122) can be a multi-scale architecture in which the initial image data structure (104) is processed at a number of scales.

In embodiments where the super-resolution machine learning model (122) is an EDSR network, the EDSR network includes a convolutional neural network (CNN). The CNN architecture has at least one residual block and at least one upsampling block, as described below.

Each residual block includes one or more layers and each layer includes one or more convolutional layers, one or more rectified linear unit functions, and one or more skip connections. The convolutional layer filters the initial image data structure (104) for a feature and generates a corresponding feature map for the feature. The feature can be, for example, an edge feature, a shape-based feature, a texture feature, a color and intensity feature, a corner feature, or a blob feature. I

n embodiments where the initial image data structure (104) includes a number of pixels, each pixel in the feature map includes at least one of a positive value or a negative value. For example, the positive value may be a positive numerical value, and the negative value may be a negative numerical value or zero.

The rectified linear unit function scores the negative value in each pixel as zero and the positive value in each pixel as the positive value. The scores can be used to identify or detect the feature in the feature map. For example, a series of positive values next to negative values may indicate an edge feature. The one or more skip connections then adds an output (e.g., the features or feature maps) of an initial layer of the one or more layers as input to a later layer of the one or more layers.

Each residual block also includes one or more upsampling blocks that generate the enhanced image data structure (106) by increasing a dimension of each scored pixel. In other words, the upsampling block increases the resolution of the initial image data structure (104) to generate the enhanced image data structure (106).

In some embodiments, the CNN architecture of the EDSR network includes one or more additional convolutional layers prior to the residual block, after the residual block, or after the upsampling block. Further, some super-resolution machine learning models include a batch normalization layer, whereas the EDSR network does not include the batch normalization layer. Such exclusion of the batch normalization layer may beneficially decrease memory usage during training as compared to, for example, a super-resolution residual network.

The server (116) also may include a server controller (116). The server controller (116) is software or application specific hardware which, when executed by the computer processor (118), controls and coordinates operation of the software or application specific hardware described herein. Thus, the sever controller (116) may control and coordinate execution of the vision-language model (124), the language model (126) and the super-resolution machine learning model (122).

The server controller (116) also may be programmed to perform specific steps with respect to FIG. 2. For example, the server controller (116) may receive a command (110) for the vision-language model (124), execute the super-resolution machine learning model (122), generate the prompt (102), or present the target information (112).

The system shown in FIG. 1 also may include one or more user devices (128). The user devices (128) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (128) are computing systems (e.g., the computing system (500) shown in FIG. 5A) that communicate with the server (116). In another embodiment, one or more of the user devices (128) may be operated by a computer technician that services the various components of the system shown in FIG. 1.

In contrast, a local user device is a device operated under the control of the organization that controls the other components of the system of FIG. 1. Thus, a local user device may be considered part of the system of FIG. 1.

In any case, the user devices (128) are computing systems (e.g., the computing system (500) shown in FIG. 5A) that communicate with the server (116). In another embodiment, one or more of the user devices (128) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for providing a vision-language model with improved accuracy, in accordance with one or more embodiments. The method of FIG. 2 may be implemented using the system of FIG. 1 and one or more of the steps may be performed on or received at one or more computer processors. The method of FIG. 2 may be characterized as a method of improving a vision-language model by increasing an accuracy of the vision-language model to process and extract information from an image.

Step 200 includes receiving a command for a vision-language model to extract target information from an initial image data structure. In some embodiments, the command is a first command and a second command is received to determine a resolution or quality of the initial image data structure. The resolution or quality may be used to determine if the vision-language model is capable or incapable of extracting the target information to within the predetermined degree of accuracy.

For example, the vision-language model may be determined to be incapable when the resolution is below a threshold. In another example, the vision-language model may be determined to be capable when the resolution is at or above the threshold. In embodiments where the vision-language model is determined to be incapable, a third command is generated to execute a super-resolution machine learning model on the initial image data structure, as described in the step 202 below.

Alternatively, the vision-language model can be determined to be capable of extracting the target information within the predetermined degree of accuracy. In such embodiments, the method moves to the step 204 and a prompt is generated with the initial image data structure.

Step 202 includes executing the super-resolution machine learning model on the initial image data structure to output an enhanced image data structure. As described above, the enhanced image data structure includes a higher pixel resolution than the initial image data structure. Thus, the enhanced image data structure increases a chance that the vision-language model can extract the target information within the predetermined degree of accuracy.

As previously described, the super-resolution machine learning model may be an enhanced deep super resolution (EDSR) network having a convolutional neural network (CNN). In such embodiments, the CNN may be a trained CNN trained with a loss function of L1, as described belo.

In general, training the CNN, and thus the EDSR network, involves an iterative process of testing the CNN against test data for which the final result is known, comparing the test results against the known result, and using a loss function to adjust the model. In some embodiments, the CNN is trained with a loss function of L1. The L1 loss function means minimizing an error which is the sum of all absolute differences between test result and the known result. In other embodiments, the CNN is trained with a loss function of L2. The L2 loss function means minimizing the error which is the sum of all squared differences between the test result and the known result.

The iterative process is repeated until the results of the model do not improve more than some pre-determined amount, or until some other termination condition occurs. Satisfaction of the termination condition is known as convergence. After training or training, the retrained language model is applied to unknown data (i.e., data for which the actual result is not known) in order to generate outputs.

The above-described training is known as the training phase of machine learning. Use of the trained CNN is known as an inference stage of machine learning.

Step 204 includes generating a prompt. The prompt may be generated by, for example, a server controller. As previously described, the prompt may include the initial image data structure and instructions. In such embodiments, the prompt is generated by adding the initial image data structure and the instructions to the prompt. The instructions instruct the vision-language model to extract the target information from the initial image data structure. In other embodiments, the prompt is generated by adding the enhanced image data structure and instructions. The instructions instruct the vision-language model to extract the target information from the enhanced image data structure.

Step 206 includes executing the vision-language model on the prompt to output the target information with at least the predetermined degree of accuracy. Executing the vision-language model on the prompt includes commanding the vision-language model to process the prompt and to generate the output. The vision-language model may be commanded by, for example, the server controller. In embodiments where the initial image data structure has a resolution or quality that is insufficient for the vision-language model to extract the target information, the vision-language model is improved by use of the super-resolution machine learning model. In other words, use of the super-resolution machine learning model on the initial image data structure to generate the enhanced image data structure enables the vision-language model to extract the target information from the enhanced image data structure.

Step 208 includes presenting the target information. Presenting the target information may include transmitting the target information to an end user of a user device, storing the target information in a data repository, or further processing the target information. Further processing the target information may include converting or formatting the target information. For example, in at least one embodiment, the vision-language model is a first language model. In such embodiments, an additional command may be received for the first language model or a second language model to format the target information into a structure language data structure. The structured language data structure may be, for example, a JSON structure.

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3 shows a dataflow for a method of providing a vision-language model with improved accuracy, in accordance with one or more embodiments. The dataflow of FIG. 3 may be implemented using the system of FIG. 1 and one or more of the steps may be performed on or received at one or more computer processors. The dataflow of FIG. 3 is a variation of the method of FIG. 2.

The dataflow begins with a command (300) that is received for a vision-language model (316) to extract target information (312) from an image. The image may be an initial image (302) or an enhanced image (308), as described below. The command may be generated by, for example, a server controller.

An initial image (302) may be received. The initial image contains the target information (312). The initial image (302) may be, for example, an invoice or a receipt having distinct fields of information such as a customer name, a customer address, products purchased by the customer, and prices of such products purchased. It may be desirable to extract this information for the purpose tracking revenue, inventory, customer purchases, etc.

However, the initial image (302) may be handwritten or have a resolution or quality such that a vision-language model (316) cannot extract the target information (312) to within a predetermined degree of accuracy (as discussed in FIG. 1). In other words, the initial image (302) may have a low resolution or quality or be handwritten such that the vision-language model (316) extracts the target information (312) with multiple errors or simply cannot extract the target information (312). Commonly, handwritten documents of low quality or may be difficult to decipher, as shown and described in FIG. 4A.

Accordingly, the initial image (302) may be analyzed to determine whether the initial image (302) is handwritten or has a low resolution automatically at step 303. Determining whether the initial image (302) is handwritten or low resolution may be performed using a vision-language model (316).

For example, an initial prompt may be generated and may include the initial image (302) and instructions for the vision-language model (316) to determine if the initial image (302) is handwritten or not handwritten (i.e., typed) or has a low resolution. For example, the instructions may also include instructions for the vision-language model (316) to determine a resolution of the initial image (302) and whether the resolution is below a threshold. The resolution is “low resolution” when below the threshold. In another example, the initial image (302) may be determined to be handwritten or have a low resolution by a user analyzing the initial image (302). By determining that the initial image (302) is handwritten or has a low resolution, the server controller can determine that the initial image (302) will be processed using super-resolution.

Regardless of how the initial image (302) is analyzed, if the initial image (302) is determined to be handwritten or have low resolution, then the initial image (302) is provided as input to a super-resolution machine learning model (306). As previously described in FIGS. 1 and 2, the super-resolution machine learning model (306) receives the initial image (302) as input and outputs an enhanced image (308).

An example of the enhanced image (308) is shown and described in FIG. 4B. The enhanced image (308) has a resolution greater than the initial image (302) and thus, increases a precision of the vision-language model (316) to extract the target information (312) from the enhanced image (308). In other words, the vision-language model (316) may have difficulty extracting the target information (312) from the initial image (302), whereas the vision-language model (316) may have a better success of extracting the target information (312) from the enhanced image (308).

The enhanced image (308) is then provided as part of a prompt (314) during generation of the prompt (314). Alternatively, if the initial image (302) is determined to not be handwritten or to have a high resolution, then the initial image (302) is not provided as input to the super-resolution machine learning model (306) and is simply provided as part of the prompt (314).

The prompt (314) includes the enhanced image (308) or the initial image (302) and instructions (310) for the vision-language model (316) to extract the target information (312). As previously described, the initial image (302) or the enhanced image (308) may be an invoice and the target information (312) may include distinct fields of information such as a customer name, a customer address, products purchased by the customer, and prices of such products purchased. Thus, the instructions (310) for the vision-language model (316) may be to, for example, extract the customer name, the customer address, the products purchased by the customer, and the corresponding prices of each product from the invoice.

After the prompt (314) is generated, the prompt (314) is provided as input to the vision-language model (316). The vision-language model (316) then extracts the target information (312) and outputs the target information (312) as extracted information (318).

The extracted information (318) may then be presented to the user, stored, or further processed. Further processing may include, for example, providing the extracted information (318) as input to a vision-language model (316) with instructions to convert the extracted information (318) into a structured language data structure. Such structured language data structure may be useful in storing and analyzing the extracted information (318). For example, the extracted information (318) can be converted into a JSON structure for easy transfer between different systems and programming languages.

FIGS. 4A and 4B show an example of an initial image prior to enhancement using a super-resolution machine learning model and an example of an enhanced image after enhancement, respectively, in accordance with one or more embodiments. The following example is for explanatory purposes only and not intended to limit the scope of one or more embodiments.

FIG. 4A shows an example initial image (400A) in which the initial image (400A) is an invoice. When the initial image (400A) is provided to a vision-language model to extract a customer name (402A), a product (404A), and a corresponding price (406A) of the product (404A), the extracted information includes multiple errors. For example, the customer name (402A) as extracted reads “Clarenyout fire Hept”, one of the products (404A) as extracted reads “July 54 Part”, and the corresponding price (406A) as extracted reads “1.00”. The multiple errors are due to the low resolution and handwritten nature of the initial image (400A) as the vision-language model cannot analyze the initial image (400) to a predetermined degree of accuracy, as described in FIGS. 1 and 2.

In contrast, in FIG. 4B, an enhanced image (400B) of the initial image (400A) is shown after having been enhanced by a super-resolution machine learning model. When the enhanced image (400B) is provided to the vision-language model to extract a customer name (402B), a product (404B), and a corresponding price (406B) of the product (404B), the extracted information includes less errors than the extracted information of the initial image (400A). For example, the customer name (402B) as extracted reads “Careyoutifire Hept”, one of the products (404B) as extracted reads “July SP Pard”, and the corresponding price (406B) as extracted reads “150”. Thus, the vision-machine learning model can operate with a higher or enhanced accuracy when extracting the target information from the enhanced image (400B) compared to the initial image (400A). In other words, the vision-machine learning model is improved with use of the super-resolution machine learning model to improve a resolution of an image for extraction of target information.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a command for a vision-language model to extract target information from an initial image data structure, wherein the vision-language model is
incapable of extracting the target information within a predetermined degree of accuracy;
executing a super-resolution machine learning model on the initial image data structure to output an enhanced image data structure, wherein the enhanced image data structure comprises a higher pixel resolution than the initial image data structure;
generating a prompt, wherein the prompt includes the enhanced image data structure and an instruction to extract the target information from the enhanced image data structure;
executing the vision-language model on the prompt to output the target information with at least the predetermined degree of accuracy; and
presenting the target information.

2. The method of claim 1, wherein the initial image data structure defines a single image and the enhanced image data structure defines a single enhanced image, and
wherein the single enhanced image is formed from the single image.

3. The method of claim 1, wherein the super-resolution machine learning model comprises at least one of a single-scale architecture or a multi-scale architecture,
wherein the single-scale architecture processes the initial image data structure at a single super-resolution scale and the multi-scale architecture processes the initial image data structure at a plurality of scales.

4. The method of claim 1, wherein the super-resolution machine learning model is at least one of an enhanced deep super-resolution (EDSR) network, a multi-scale deep super-resolution system, and a super-resolution residual network.

5. The method of claim 4, wherein the initial image data structure comprises a plurality of pixels and the super-resolution machine learning model comprises the EDSR network, and wherein the EDSR network comprises a convolutional neural network having an architecture comprising:
a residual block comprising:
one or more layers, wherein each layer of the one or more layers comprises:
one or more convolutional layers that filter the initial image data for a feature and generates a corresponding feature map for the feature,
wherein each pixel of the plurality of pixels in the feature map includes at least one of a positive value and a negative value,
one or more rectified linear unit functions that detect the feature in the feature map by scoring the negative value in each pixel as zero and the positive value in each pixel as the positive value, and
one or more skip connections that add the output of an initial layer of the one or more layers as input to a later layer of the one or more layers; and
an upsampling block that generates the enhanced image data structure by increasing a dimension of each scored pixel, wherein the convolutional
neural network does not have a batch normalization layer.

6. The method of claim 5, wherein the feature comprises at least one of an edge feature, a shape-based feature, a texture feature, a color and intensity feature, a corner feature, and a blob feature.

7. The method of claim 5, further comprising:
prior to executing the super-resolution machine learning model, training the EDSR network with a loss function of L1.

8. The method of claim 5, wherein the architecture further comprises one or more additional convolutional layers at a time comprising at least one of prior to the residual block, after the residual block, and after the upsampling block.

9. The method of claim 1, wherein the method further comprises:
after executing the vision-language model, receiving an additional command for at least one of the vision-language model and a language model to format the
target information into a structured language data structure.

10. The method of claim 1, wherein the command is a first command, and wherein the method further comprises, before receiving the first command:
receiving a second command for the vision-language model to determine that the a resolution of the initial image data structure, wherein the vision-language model is incapable of extracting the target information with a predetermined degree of accuracy at the determined resolution; and
generating, in response to determining the resolution of the initial image data structure, a third command for the vision-language model to execute the super-resolution machine learning model on the initial image data structure.

11. A system comprising:
a computer processor;
a data repository in communication with the computer processor, wherein the data
repository stores:
a command,
target information,
an initial image data structure,
a predetermined degree of accuracy,
an enhanced image data structure, and
a prompt comprising the enhanced image data structure and an instruction;
a vision-language model which, when executed by the computer processor on the prompt, outputs the target information;
a super-resolution machine learning model which, when executed by the computer processor on the initial image data structure, outputs the enhanced image data structure; and
a server controller which, when executed by the computer processor, presents the target information.

12. The system of claim 11, wherein the initial image data structure defines a single image and the enhanced image data structure defines a single enhanced image formed based on the single image.

13. The system of claim 11, wherein the super-resolution machine learning model comprises at least one of a single-scale architecture or a multi-scale architecture, wherein the single-scale architecture processes the initial image data structure at a
single super-resolution scale and the multi-scale architecture processes the initial image data structure at various scales.

14. The system of claim 11, wherein the super-resolution machine learning model is at least one of an enhanced deep super-resolution (EDSR) network, a multi-scale deep super-resolution system, and a super-resolution residual network.

15. The system of claim 14, wherein the initial image data structure comprises a plurality of pixels and the super-resolution machine learning model comprises the EDSR network, and wherein the EDSR network comprises a convolutional neural network having an architecture comprising:
a residual block comprising:
one or more layers, wherein each layer of the one or more layers comprises:
one or more convolutional layers that filter the initial image data for a feature and generates a corresponding feature map for the feature,
wherein each pixel of the plurality of pixels in the feature map includes at least one of a positive value and a negative value,
one or more rectified linear unit functions that detect the feature in the feature map by scoring the negative value in each pixel as zero and the positive value in each pixel as the positive value, and
one or more skip connections that add the output of an initial layer of the one or more layers as input to a later layer of the one or more layers; and
an upsampling block that generates the enhanced image data structure by increasing a dimension of each pixel, wherein the convolutional neural network does not have a batch normalization layer.

16. The system of claim 15, wherein the feature comprises at least one of an edge feature, a shape-based feature, a texture feature, a color and intensity feature, a corner feature, and a blob feature.

17. The system of claim 15, wherein prior to the computer processor executing the EDSR network, the computer processor executes an additional process comprising:
training the EDSR network with a loss function of L1.

18. The system of claim 15, wherein the architecture further comprises one or more additional convolutional layers at at least one of prior to the residual block, after the residual block, and after the upsampling block.

19. The system of claim 11, wherein at least one of the vision-language model or a language model, when executed by the computer processor, is further programmed to perform, after outputting the target information, an additional process comprising:
formatting the target information into a structured language data structure.

20. A method comprising:
receiving a command for a vision-language model to extract target information from an initial image data structure,
wherein the vision-language model is incapable of extracting the target information with a predetermined degree of accuracy, and
wherein the initial image data structure comprises a plurality of pixels;
executing an enhanced deep super-resolution (EDSR) network on the initial image data structure to output an enhanced image data structure, wherein the enhanced image data structure comprises a higher pixel resolution than the initial image data structure,
wherein the EDSR network comprises a convolutional neural network having an architecture comprising:
a residual block comprising:
one or more layers, wherein each layer of the one or more layers comprises:
one or more convolutional layers that filter the initial image data for a feature and generates a corresponding feature map for the feature,
wherein each pixel of the plurality of pixels in the feature map includes at least one of a positive value and a negative value,
one or more rectified linear unit functions that detect the feature in the feature map by scoring the negative value in each pixel as zero and the positive value in each pixel as the positive value, and
one or more skip connections that add the output of an initial layer of the one or more layers as input to a later layer of the one or more layers; and
an upsampling block that generates the enhanced image data structure by increasing the dimension of each pixel, wherein the convolutional neural network does not have a batch normalization layer;
generating a prompt, wherein the prompt includes the enhanced image data structure and an instruction to extract the target information from the enhanced image data structure;
executing the vision-language model on the prompt to output the target information with at least the predetermined degree of accuracy; and
presenting the target information.
